(19) United States
(12) Patent Application Publication
(10) Pub. No.: US 2025/0068969 A1
(43) Pub. Date: Feb. 27, 2025

(54) ONLINE SYSTEM WITH BANDIT FEATURE AND AUTO-REGRESSIVE TEMPORAL STRUCTURE

(71) Applicants: International Business Machines Corporation, Armonk, NY (US); Massachusetts Institute of Technology, Cambridge, MA (US)

(72) Inventors: Qinyi Chen, Cambridge, MA (US); Negin Golrezaei, Cambridge, MA (US); Djallel Bouneffouf, Poughkeepsie, NY (US)

(21) Appl. No.: 18/627,702

(22) Filed: Apr. 5, 2024

Related U.S. Application Data
(60) Provisional application No. 63/534,420, filed on Aug. 24, 2023.

(51) Int. Cl. G06N 20/00

(52) U.S. Cl. CPC G06N 20/00

(57) ABSTRACT

A multi-armed bandit (MAB) problem is obtained and a per-round regret lower bound is determined, wherein a corresponding regret is measured against a benchmark. The multi-armed bandit problem is provided to an algorithm that has a per-round regret that is close to the determined per-round regret lower bound, wherein the algorithm dynamically adapts to changes and discards irrelevant past information by alternating between recently pulled arms and unpulled arms having potential, wherein the alternating comprises updating an estimate of an expected reward of each arm within each epoch and an estimate for an error bound that captures an amount of error contained in the estimate of the expected reward for each arm within each epoch based on the auto-regressive temporal structure with trend components, and restarting the algorithm.

### CROSS-REFERENCE TO RELATED APPLICATIONS

This application claims the benefit of U.S. provisional patent application No. 63/534,420 filed Aug. 24, 2023, the complete disclosure of which is expressly incorporated herein by reference in its entirety for all purposes.

### STATEMENT REGARDING PRIOR DISCLOSURES BY THE INVENTOR OR A JOINT INVENTOR

The following disclosure(s) are submitted under 35 U.S.C. 102(b)(1)(A):
Qinyi Chen, Negin Golrezaei, Djallel Bouneffouf, Dynamic Bandits with an Auto-Regressive Temporal Structure, arXiv: 2210.16386v2 5 Apr. 2023.
Qinyi Chen, Negin Golrezaei, Djallel Bouneffouf, Dynamic Bandits with an Auto-Regressive Temporal Structure, arXiv: 2210.16386v1 28 Oct. 2022.
Qinyi Chen, Negin Golrezaei, Djallel Bouneffouf, Dynamic Bandits with an Auto-Regressive Temporal Structure, available at SSRN, version posted 5 Apr. 2023.
Qinyi Chen, Negin Golrezaei, Djallel Bouneffouf, Non-Stationary Bandits with Auto-Regressive Temporal Dependency, Published online at OpenReview: 21 Sep. 2023, Last Modified online at OpenReview: 2 Nov. 2023, Presented at Thirty-seventh Conference on Neural Information Processing Systems 2023 Nov. 2 and published 10 Dec. 2023.

### BACKGROUND

The present invention relates generally to the electrical, electronic and computer arts and, more particularly, to machine learning.

Multi-armed bandit (MAB) problems are mainly studied under two extreme settings (known as stochastic and adversarial). These two settings, however, do not capture realistic environments, such as search engines and marketing and advertising, in which rewards stochastically change in time. Moreover, fast-changing temporal structures like alternating and restarting (AR) processes are prevalent in real-world applications.

### BRIEF SUMMARY

Principles of the invention provide systems and techniques for online system with bandit feature and auto-regressive temporal structure. In one aspect, an exemplary method includes the operations of obtaining, using at least one hardware processor, the multi-armed bandit (MAB) problem; determining, using the at least one hardware processor, a per-round regret lower bound, wherein a corresponding regret is measured against a benchmark; and providing, using the at least one hardware processor, the multi-armed bandit problem to an algorithm that has a per-round regret that is close to the determined per-round regret lower bound, wherein the algorithm dynamically adapts to changes and discards irrelevant past information by: alternating, using the at least one hardware processor, between recently pulled arms and unpulled arms having potential, wherein the alternating comprises updating an estimate of an expected reward of each arm within each epoch and an estimate for an error bound that captures an amount of error contained in the estimate of the expected reward for each arm within each epoch based on the auto-regressive temporal structure with trend components; and restarting, using the at least one hardware processor, the algorithm.

In one aspect, a computer program product comprises one or more tangible computer-readable storage media and program instructions stored on at least one of the one or more tangible computer-readable storage media, the program instructions executable by a processor, the program instructions comprising obtaining the multi-armed bandit (MAB) problem; determining a per-round regret lower bound, wherein a corresponding regret is measured against a benchmark; and providing the multi-armed bandit problem to an algorithm that has a per-round regret that is close to the determined per-round regret lower bound, wherein the algorithm dynamically adapts to changes and discards irrelevant past information by: alternating between recently pulled arms and unpulled arms having potential, wherein the alternating comprises updating an estimate of an expected reward of each arm within each epoch and an estimate for an error bound that captures an amount of error contained in the estimate of the expected reward for each arm within each epoch based on an auto-regressive temporal structure with trend components; and restarting the algorithm.

In one aspect, an apparatus comprises a memory and at least one processor, coupled to the memory, and operative to perform operations comprising obtaining the multi-armed bandit (MAB) problem; determining a per-round regret lower bound, wherein a corresponding regret is measured against a benchmark; and providing the multi-armed bandit problem to an algorithm that has a per-round regret that is close to the determined per-round regret lower bound, wherein the algorithm dynamically adapts to changes and discards irrelevant past information by: alternating between recently pulled arms and unpulled arms having potential, wherein the alternating comprises updating an estimate of an expected reward of each arm within each epoch and an estimate for an error bound that captures an amount of error contained in the estimate of the expected reward for each arm within each epoch based on an auto-regressive temporal structure with trend components; and restarting the algorithm.

As used herein, “facilitating” an action includes performing the action, making the action easier, helping to carry the action out, or causing the action to be performed. Thus, by way of example and not limitation, instructions executing on a processor might facilitate an action carried out by instructions executing on a remote processor, by sending appropriate data or commands to cause or aid the action to be performed. Where an actor facilitates an action by other than performing the action, the action is nevertheless performed by some entity or combination of entities.

Techniques as disclosed herein can provide substantial beneficial technical effects. Some embodiments may not have these potential advantages and these potential advantages are not necessarily required of all embodiments. By way of example only and without limitation, one or more embodiments may provide one or more of:
improvements to the technological process of computerized machine learning in the field of multi-armed bandits (MABs) by characterizing a per-round regret lower bound, where the regret is measured against a strong (dynamic) benchmark;
improvements to the technological process of computerized machine learning in the field of multi-armed bandits (MABs), using an algorithm whose per-round regret almost matches a regret lower bound according to aspects of the invention, and relies on two mechanisms: (i) alternating between recently pulled arms and unpulled arms with potential, and (ii) restarting;
improvement to the technological process of computerized machine learning in the field of multi-armed bandits (MABs), in realistic environments where rewards stochastically change in time, using the above-mentioned algorithm;
in a network routing environment, techniques for handling the time-varying nature of the routes of a network and taking advantage of the correlation of the throughput performance of routes over time, while discarding outdated performance information, thereby improving the technological process of efficiently routing packets in a computer network; and
improvement to the technological process of computerized machine learning in the field of multi-armed bandits (MABs) by providing mechanisms that enable the algorithm to dynamically adapt to changes and discard irrelevant past information at a suitable rate.

These and other features and advantages will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1 is a graph illustrating the probability density function (PDF) of the stationary distribution of an AR process with reflective boundaries for α∈{0.3, 0.6, 0.9} with σ=0.8 and R=1, in accordance with an example embodiment;

FIG. 2 is a graph illustrating a comparison of the order of the regret upper bound in Theorem 6.1 for a naive algorithm and the order of the lower bound in Theorem 4.1, in accordance with an example embodiment;

FIG. 3 is a table illustrating the performance of an “AR2” alternating and restarting algorithm in accordance with an exemplary embodiment, compared against benchmark algorithms, in both instances with small αᵢ's ( [symbol] [αᵢ]=0.4) and large αᵢ's ( [symbol] [αᵢ ]=0.9);

FIG. 4A depicts a first example “AR2” alternating and restarting (AR) algorithm for dynamic AR bandits, in accordance with an example embodiment;

FIG. 4B is a second example alternating and restarting (AR) algorithm for dynamic AR bandits, in accordance with an example embodiment;

FIG. 5A is a table of the mean and standard deviation (in parenthesis) of normalized regret incurred by each algorithm at T=10,000, in accordance with an example embodiment;

FIG. 5B illustrates box plots of normalized regret incurred by each algorithm at T=10,000, in accordance with an example embodiment; and

FIG. 6 depicts a computing environment according to an embodiment of the present invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

Principles of inventions described herein will be in the context of illustrative embodiments. Moreover, it will become apparent to those skilled in the art given the teachings herein that numerous modifications can be made to the embodiments shown that are within the scope of the claims. That is, no limitations with respect to the embodiments shown and described herein are intended or should be inferred.

Generally, a dynamic MAB problem with stochastic temporal structure is introduced, where the expected reward of each arm is governed by an auto-regressive (AR) model. Due to the dynamic nature of the rewards, simple “explore and commit” policies fail, as all arms have to be explored continuously over time. This is formalized by characterizing a per-round regret lower bound, where the regret is measured against a strong (dynamic) benchmark. In one example embodiment, an algorithm whose per-round regret almost matches a regret lower bound according to aspects of the invention relies on two mechanisms: (i) alternating between recently pulled arms and unpulled arms with potential, and (ii) restarting. These mechanisms enable the algorithm to dynamically adapt to changes and discard irrelevant past information at a suitable rate. In numerical studies, the strength of an exemplary algorithm under different types of non-stationary settings is demonstrated.

### Introduction

The multi-armed bandit (MAB) is a framework for studying online decision-making under uncertainty. In the basic stochastic formulation of the MAB problem, there are k arms, each having a fixed, unknown and independent reward distribution, and the goal is to identify the arm with the highest expected reward while experimenting with the arms over the course of T rounds. Another approach that is widely studied in the MAB literature focuses on the adversarial setting, which, unlike the basic stochastic formulation, allows the reward distributions to be determined by an adversary and to change arbitrarily in time. Due to the enormous unpredictability of the adversary, the goal is to approach the performance of the best static benchmark, which is the single best arm that can be pulled in hindsight.

The assumptions in either the stochastic or adversarial setting, however, are often deemed too stringent and no longer valid in most real-world applications, such as online advertising, online auctions, demand forecasting, online recommendation systems, and dynamic pricing, where the reward distributions in fact evolve with time following some intrinsic temporal structure. Consider, for example, a web search engine in which the goal is to maximize its revenue by showing users ads with the highest click through rate (CTR). In this setting, the CTRs of ads keep evolving over time, where the amounts of the changes can in fact be linear in T. The changes in CTR can be modeled using certain temporal structures (e.g., a time series process). Another example is marketing and advertising, where stores would like to display products with the highest demand. To do so, they need to experiment with many products to learn their demand, where product demand may vary over time following a specific temporal structure, such as time series models.

In one example embodiment, the previously restrictive assumptions on the reward distributions are relaxed by studying a dynamic bandit problem, in which the reward of each arm has a temporal structure and the amounts of the changes is linear in T. To impose temporal structure, a simple yet popular auto-regressive (AR) model is considered. Prior-art AR models are one of the most commonly studied time series models and are widely adopted in real-world applications that involve non-stationary, including prediction of sales and demands, advertising and marketing.

Most conventional approaches focus on two types of non-stationary bandits, namely the rested bandits and restless bandits. In rested bandits, only the expected reward of the arm that is being pulled will change, while in restless bandits, the expected reward of each arm changes at each round according to a known yet arbitrary stochastic process, regardless of whether the arm is pulled. Recently, there has also been a third stream of literature that studies non-stationary bandits where the changes in reward distributions depend on both which arm is pulled and the time period that passes by since its last pull. The dynamic MAB considered herein belongs to the restless setting since the reward distributions change at each round based on AR processes, independent of the actions. Restless bandits, however, are known to be a difficult and intractable problem, and many works thus focus on studying its approximation or relaxation. However, the AR process is much more unpredictable than the temporal structures studied previously, due to its infinite state space and the fast decay in the values of the past observations. A different approach that is designed specifically for adapting to the rapid changes attributed to the AR process is thus taken.

In one example embodiment, a novel setting of dynamic bandits is introduced where the reward distributions evolve according to an AR-based temporal structure. To measure the performance of algorithms in an exemplary setting, the notion of per-round steady state dynamic regret is used, where the dynamic regret at a given round is the difference between the collected reward and the highest expected reward at that round. Observe that such a notion is more demanding than the static regret used in stochastic and adversarial MAB problems, since the algorithm always competes against the best arm at each round and needs to adapt well to the temporal changes.

### Regret Lower Bound

The per-round steady state regret lower bound is characterized as a function of the stochastic rate of the change and the temporal correlation of the rewards in Theorem 4.1. The exemplary result shows that, in the AR setting, the per-round dynamic regret does not go to zero as T increases, implying that any good algorithm should keep exploring over time. Furthermore, it shows that the regret lower bound increases as the stochastic rate of the change and the temporal correlation of the rewards increase. The exemplary regret lower bound formally characterizes the challenges embedded in the rapidly changing AR temporal process.

### An Alternating-and-Restarting Algorithm

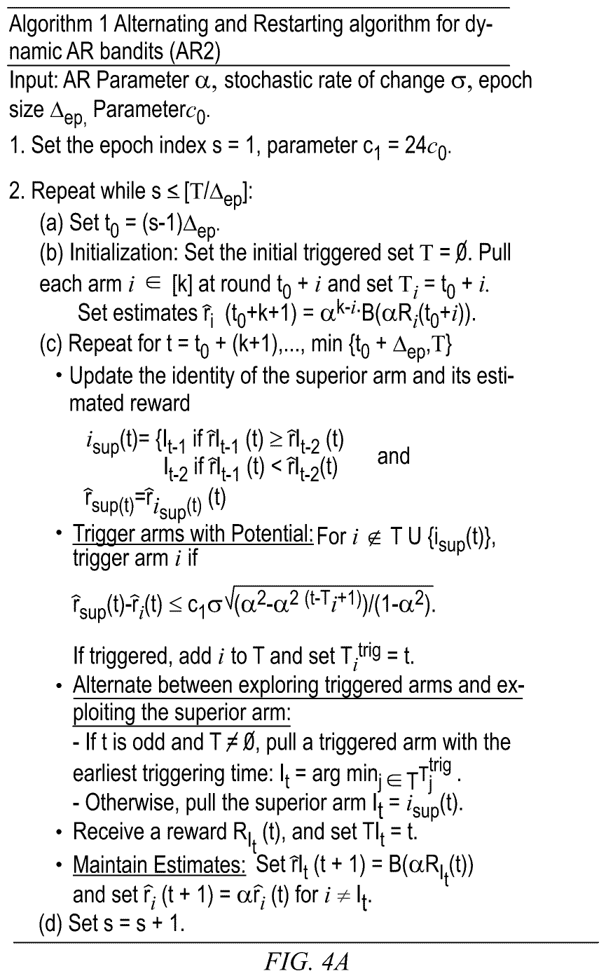

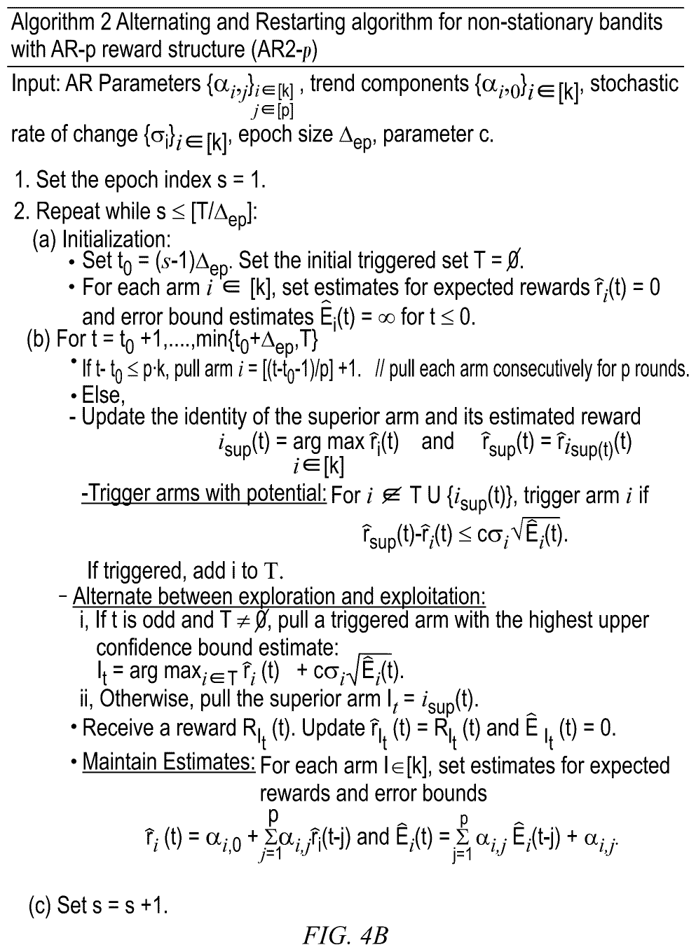

FIG. 4A is a first example alternating and restarting (AR) algorithm for dynamic AR bandits, in accordance with an example embodiment. The exemplary algorithm is referred to herein as the “Alternating and Restarting” algorithm (AR2) for dynamic “AR” bandits. Embodiments of AR2 advantageously rely on two mechanisms: (i) alternating between exploration and exploitation throughout the horizon; and (ii) adopting a restarting mechanism. Regarding (i), during exploitation, AR2 goes with a superior arm that is expected to have high reward based on recently collected information; during exploration, it pulls one of the triggered arms, which have the potential to outperform the superior arm (see definitions in the section entitled “Algorithm”). Regarding (ii), as noted, AR2 also adopts a restarting mechanism, which allows AR2 to get rid of potentially misleading information and examine arms that are not necessarily triggered but which may have the potential to surpass triggered arms. Note that references herein to “AR2” should be understood generally to refer to exemplary embodiments thereof. Via these two mechanisms, AR2 balances two levels of tradeoffs-exploration and exploitation; “remembering” and “forgetting”-intrinsic to the fast-changing environment introduced by the AR process; see more details in the section entitled “Algorithm”. An upper bound on the regret of AR2 (Theorem 6.2) is provided and it is shown that it is close to the regret lower bound. From a technical point of view, the analysis of the upper bound is rather intricate, as it involves distributing the regret incurred at each round over subsequent rounds, and identifying a high-probability event on which the rewards do not experience drastic changes (see the section entitled “Proof of Theorem 6.2”).

### Numerical Studies

The efficacy of AR2 was numerically verified by comparing it against several benchmark algorithms designed for both stationary and non-stationary settings. It is shown that the exemplary algorithm outperforms traditional algorithms (e.g., “explore-then-commit” and upper confidence bound (UCB), existing algorithms designed for non-stationary bandits, and a modified UCB algorithm that takes into account the AR temporal structure.

2 Dynamic MAB Problem with Stochastic Temporal Structure

### Expected Rewards

Consider a dynamic MAB problem with k arms over T rounds. The state (expected reward) of arm i∈[k] at any round t∈[T] is denoted by rᵢ(t), where rᵢ(t)∈[−R, +R]. Conditioned on the state rᵢ(t), the realized reward of arm i at round t, denoted by Rᵢ(t), is given by

$${R}_{i} ( t ) = {r}_{i} ( t ) + {ϵ}_{i} ( t ) ,$$

where ϵᵢ(t)˜N(0,σ) is independent across arms and rounds and σ∈(0,1) is called the stochastic rate of change.

(In a more general setting where each arm i∈[k] has a different, unknown stochastic rate of change σᵢ, as long as there is an upper bound σ≥maxᵢσᵢ, all of the exemplary theoretical results naturally carry over with the same dependency on σ.)

### Evolution of Expected Rewards

The expected reward of each arm i∈[k], rᵢ(t), evolves over time. In an exemplary model, it is assumed that rᵢ(t) undergoes an independent AR-1 process, i.e., rᵢ(t+1)=α(rᵢ(t)+rᵢ(t))=αRᵢ(t), or equivalently, Rᵢ(t+1)=αRᵢ(t)+ϵᵢ(t+1), where α∈(0,1) is the parameter of the AR-1 model and can be used as a proxy to measure temporal correlation over time. As α increases, the temporal correlation increases. (This can be seen from the autocorrelation function (ACF) of a time series {xₜ}, which gives correlation between xₜ and xₜ₊ₕ for h≥1. The ACF of an AR-1 model with parameter α is α^{h}, i.e. the smaller the α, the faster the correlation between past and future values decays.)

The unboundedness of the exemplary expected reward as an AR-1 process, however, complicates the exemplary analysis without providing extra insights. In most real-world applications, boundedness is also a common assumption on the expected rewards. For this reason, the expected reward rᵢ(t) is further bound using a reflective boundary. Formally, it is assumed that rᵢ(t) follows an independent AR-1 process with reflective boundaries [−R, R]:

$${r}_{i} ( t + 1 ) = B ( α ( {r}_{i} ( t ) + {ϵ}_{i} ( t ) ) ) = B ( α {R}_{i} ( t ) ) ,$$

where B(y)=y′−R if y′∈[o, 2R] and 3R−y′ otherwise, with y′=(y+R)mod 4R.

In the exemplary model, two assumptions on the AR parameter are made: (i) all arms share the same AR parameter α; and (ii) the AR parameter α is known to the decision maker. These assumptions are made since a pertinent aspect is the shedding of light on the challenges and tradeoffs embedded in a fast-changing environment introduced by the AR temporal structure, rather than learning the AR parameters. That being said, the exemplary model is further generalized in numerical studies by considering heterogeneous AR parameters αᵢ for each arm i∈[k], and the setting when only a rough estimate of the AR parameter(s) is available. The exemplary algorithm is shown to perform well under the more general setting without the aforementioned assumptions; see the section entitled “Numerical Studies” for more details.

The aforementioned assumptions can be well-justified in some real-world applications where the AR evolution is introduced by exogenous factors that can be well-estimated by the decision maker. Consider an online platform that displays a product in a variety of colors. Let each arm represent the product of a given color, whose reward is the consumer demand for this color. The evolution of demands here can be modeled with an AR-1 process, where the AR parameter α represents the amount of consumer inertia, i.e., the tendency of consumers to keep selecting the color(s) they liked previously. The AR process captures the correlation between past and future demands which, in turn, introduces some trend where some colors remain popular for a period of time. Since the arms are variations of the same product, the AR parameter α (i.e., the amount of consumer inertia) is mostly determined by exogenous factors that impact all arms in the same way. Further, the platform itself can also readily determine the amount of consumer inertia by means of its past data.

### Feedback Structure and Goal

One goal is to design an algorithm that obtains high reward against a strong dynamic benchmark that, in every round t, pulls an arm that has the highest expected reward. This benchmark is much more demanding than the time-invariant benchmark used in traditional MAB literature. Obtaining good performance against the dynamic benchmark is particularly challenging as, in any round t∈[T], one arm can be pulled and only the reward of the pulled arms can be observed. Not being able to observe the reward of unpulled arms in dynamic and time-varying environments introduces missing values in the AR process associated with arms. This, in turn, deteriorates the prediction quality of the future expected rewards and the performance of any algorithm that relies on such predictions. How to measure the performance of any non-anticipating algorithm is discussed elsewhere herein.

### Definition 2.1 (Dynamic Steady State Regret)

Consider a non-anticipating algorithm A that pulls arm Iₜ at round t∈[T]. The dynamic regret of the algorithm at round t is defined as REG_{A}(t)=r*(t)−rₗ_{ₜ}(t), where r*(t)=max_{i∈[k]}{rᵢ(t)} is the maximum expected reward at round t. Furthermore, the per-round steady state regret of algorithm A is defined as

$$\overline{R E {G}_{A}} = lim {sup}_{T \to ∞} 𝔼 [ \frac{1}{T} {\sum }_{t = 1}^{T} R E {G}_{A} ( t ) ] .$$

One goal is to design an algorithm with a small per-round steady state regret, where the per-round steady state regret is presented as a function of the stochastic rate of the change (σ) and the temporal correlation of the rewards (α).

### 3 Stationary Distributions of Rewards

The stationary distribution of the expected reward rᵢ(t) is characterized below.

### Lemma 3.1 (Stationary Distributions of Rewards)

The stationary distribution of rᵢ(t) has the following probability density function (PDF), denoted by f:[−R, R]→ [symbol] ⁺.

$$f ( x ) = C ( α , σ ) exp ( \frac{( α - 1 ) {x}^{2}}{{α}^{2} {σ}^{2}} ) x ∈ [ - R , R ] ,$$

where

$$C ( α , σ ) = \sqrt{1 - α} / ( \sqrt{π} ασ erf ( \frac{R \sqrt{1 - α}}{α σ} ) )$$

is a normalization factor and

$$erf ( z ) = \frac{2}{\sqrt{π}} {\int }_{0}^{z} {e}^{- {s}^{2}} ds$$

is the error function.

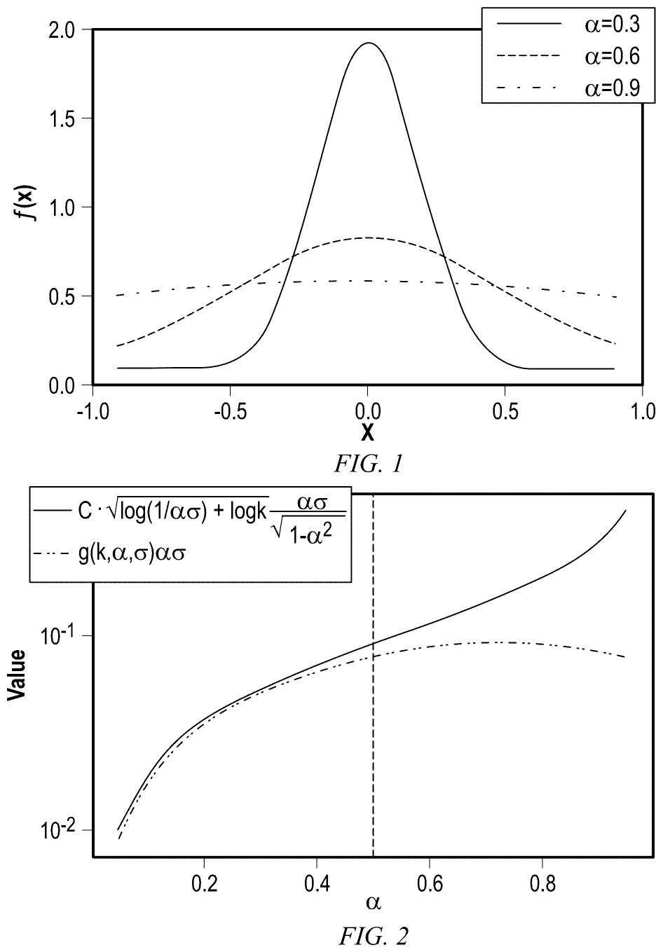

It is noted that, for any fixed σ∈(0, 1), when α→1, the stationary distribution of rᵢ(t) can be well approximated by a uniform distribution. FIG. 1 is a graph illustrating the PDF of the stationary distribution of the AR process with_reflective boundaries for α∈{0.3, 0.6, 0.9} with σ=0.8 and R=1, in accordance with an example embodiment. In the other extreme case, when α→0, it can be seen both from FIG. 1 and from the definition of f(x) in Lemma 3.1 that the distribution can be approximated by a normal distribution.

### 4 Regret Lower Bound

A lower bound on the best achievable dynamic per-round steady state regret is provided below.

### Theorem 4.1 (Regret Lower Bound)

Consider a dynamic MAB problem with k arms, where the expected reward of each arm evolves as an independent AR-1 process with parameter α and stochastic rate of change σ and reflective boundaries [−R, R]. Then the per-round steady state regret of any algorithm A is at least Ω(g(k, α, σ)ασ), where:

$$g ( k , α , σ ) = k ( k - 1 ) {\int }_{0}^{α σ} {\int }_{- R}^{R} {F ( x )}^{k - 2} f ( x ) f ( x + z ) d xdz . \qquad ( 1 )$$

Here, f(x) is the PDF of the stationary distribution of rᵢ(t) as defined in Lemma 3.1, and F(x)=∫_{-∞}^{x}f(z)dz is the cumulative density function (CDF) of the stationary distribution_of rᵢ(t).

It is worth noting that, at any given round t, even if an algorithm A has access to all of the past information, due to the stochasticity introduced by the noises ϵᵢ(t), the algorithm A will select a sub-optimal arm at the (t+1)th round with constant probability. It is first shown that the probability that the expected rewards of the two best arms at round t are within ασ of each other can be expressed as g(k, α, σ) defined in (1). It is next shown that if the two best arms are ασ close, then at round t+1, A would incur Ω(ασ) regret with constant_probability.

In the extreme case when α is close to one, the stationary distribution of rᵢ(t) can be approximated with a uniform distribution (see the section entitled “Stationary Distributions of Rewards”). Using the uniform approximation, it can be shown that g(k, α, σ)=Ω(kασ). This then yields a regret lower bound of order Ω(kα²σ²). An important implication of Theorem 4.1 is that in dynamic bandits, when the regret is measured against a strong dynamic benchmark, the best achievable per-round regret does not converge to zero. This stands in contrast to stationary or adversarial bandits with the time-invariant benchmark for which there are algorithms (e.g., UCB for stationary bandits; a conventional exponential-weight algorithm for adversarial bandits) that asymptotically achieve zero per-round regret as T goes to infinity. In the dynamic setting, each arm undergoes changes that scale linearly with T. The presence of missing values along with the rapid changes of each arm's expected reward makes it difficult for any algorithm to adapt to the changing environment in time.

### 5 Algorithm

An algorithm, AR2 (which stands for “Alternating and Restarting” algorithm for dynamic “AR” bandits), is presented and analyzed herein. The exemplary algorithm AR2, presented in Algorithm 1 of FIG. 4A, works in epochs of a predetermined length. Within each epoch, the algorithm keeps and updates an estimate of the expected reward of each arm i∈[k]. Having these estimates, the algorithm alternates between exploitation and exploration steps. In the exploitation step, AR2 plays the arm that is called the superior arm herein. The superior arm is identified using the estimate of the expected rewards and is expected to yield a high reward. In the exploration step, AR2 plays a triggered arm that has not been pulled recently, but has the potential of generating a higher expected reward than the superior arm. Observe that, in order to adapt to changes in the arms' rewards, the algorithm never stops exploring. After the end of the current epoch is reached, the algorithm is restarted at the beginning of the next epoch. When restarting, the estimates that were previously maintained for each arm are discarded and the set of triggered arms is emptied, which allows the creation of new estimates of the expected rewards for each arm with a fresh outlook.

AR2 dynamically balances two tradeoffs intrinsic to the dynamic MAB problem: (i) it deals with the tradeoff of exploration and exploitation by alternating between exploiting the superior arm and exploring the triggered arm within an epoch; and (ii) via restarting, it also deals with the tradeoff between “remembering” and “forgetting”. Although maintaining estimates of the expected reward for each arm helps us identify the superior and triggered arms, there can be untriggered arms whose expected rewards experience sudden, drastic changes, and the exemplary estimates no longer reflect their expected rewards truthfully. Restarting discards past observations that become misleading due to the rapidly changing environment, and enables the capture of the untriggered arms with potential. In the following, more details on how AR2 works are described.

### Maintaining Estimates of Expected Reward of Arms

For any round t and arm i∈[k], let τᵢ(t) be the last round before t (including t) at which arm i is pulled by the exemplary algorithm, and let τᵢ^{next}(t) be the next round after t (excluding t) at which arm i gets pulled. Let Δτᵢ(t)=τᵢ^{next}(t)−τᵢ(t) be the gap between two consecutive pulls of arm i around t. Define \hat{r}ᵢ(t) as the estimate of the reward of arm i at t based on the most recent observed reward of arm i (which is, Rᵢ(τᵢ(t))). Then, if τᵢ(t)=t−1, i.e., the most recent pull of arm i is the previous round t−1, \hat{r}ᵢ(t)=\hat{r}ᵢ(τᵢ(t)+1)=B(αRᵢ(τᵢ(t)))=rᵢ(τᵢ(t)+1), which is precisely the expected reward of arm i at round τᵢ(t)+1. If τᵢ(t)=t−t′, for some t′≥2, \hat{r}ᵢ(t) is defined with the following recursive relationship: \hat{r}ᵢ(t)=α\hat{r}ᵢ(t−1). This then leads to:

$${\hat{r}}_{i} ( t ) = {α}^{{t}^{′} - 1} {\hat{r}}_{i} ( {τ}_{i} ( t ) + 1 ) = {α}^{{t}^{′} - 1} {r}_{i} ( {τ}_{i} ( t ) + 1 ) .$$

Finally, note that AR2 updates the estimate \hat{r}ᵢ(t) strictly before it selects which arm to pull at round t. So if τᵢ(t)=t, the estimate \hat{r}ᵢ(t) is still based on the observation strictly before t:

$${\hat{r}}_{i} ( t ) = α {\hat{r}}_{i} ( t - 1 ) = {α}^{Δ {τ}_{i} ( t - 1 ) - 1} {\hat{r}}_{i} ( {τ}_{i} ( t - 1 ) + 1 ) .$$

### Superior Arms

The superior arm at round t, denoted by iₛᵤₚ(t), is one of the two most recently pulled arms, i.e., Iₜ₋₁ or Iₜ₋₂, that has the higher estimated reward; that is,

$${i}_{sup} ( t ) = \{ \begin{matrix}{I}_{t - 1} & if {\hat{r}}_{{I}_{t - 1}} ( t ) \geq {\hat{r}}_{{I}_{t - 2}} ( t ) \\ {I}_{t - 2} & if {\hat{r}}_{{I}_{t - 1}} ( t ) < {\hat{r}}_{{I}_{t - 2}} ( t )\end{matrix} \qquad ( 2 )$$

Recall that \hat{r}_{I}_{_{t−1}}(t)=B(αR_{I}_{_{t−1}}(t−1)) and \hat{r}_{I}_{_{t−2}}(t)=B(αR_{I}_{_{t−2}}(t−2)). \hat{r}ₛᵤₚ(t)=\hat{r}ᵢ_{ₛᵤₚ}₍ₜ₎(t) is defined as the estimated reward of the superior arm at round t. It is noted here that, for simplicity of analysis, the definition of the superior arm only considers the two most recently pulled arms. In fact, the superior arm can be set to be the one with the highest estimated reward among the m most recently pulled arms for any constant m≥2. A similar theoretical analysis will then yield the same theoretical guarantee, as shown in Theorem 6.2. The robustness of AR2 is further verified to the choice of m in the exemplary numerical studies, where all arms are considered as potential candidates for the superior arm, and it is observed that AR2 maintains its competitive performance (see discussion of numerical studies elsewhere herein).

### Triggered Arms

As stated earlier, in order to adapt to changes, AR2 identifies and keeps track of a set of arms with potential that are not pulled recently. These arms are referred to as triggered arms and their associated set is denoted by T. In a round t, an arm i≠iₛᵤₚ(t) gets triggered if the following triggering criteria is satisfied: \hat{r}ₛᵤₚ(t)−\hat{r}ᵢ(t)≤cᵢσ{square root over ((α²−α^{2(t-τ}^{ᵢ}^{(t)+1)}/(1−α²))}. Here, c₁ depends on α, σ; and the value of c₁ is determined later. The earliest such time t>τᵢ(t) is called the triggering time of arm i and it is denoted as τᵢ^{trig}(t). If arm i is triggered, it is added to the triggered set T. When arm i gets pulled or is chosen as the superior arm, it is removed from T.

### 6 Regret of Algorithm AR2

The exemplary algorithm AR2 works for the AR-1 model with any choice of parameter α∈(0, 1). However, it turns out that the problem is less challenging when the future is weakly correlated with the past (i.e., when α is small). It is shown in Theorem 6.1 that even the naive algorithm (which randomly selects one arm in the beginning, and keeps selecting the same arm throughout the horizon) achieves near-optimal performance when α is small, such as close to zero. The skilled artisan will appreciate that, given the teachings herein, the parameter α may be selected heuristically to be a value in the range (0, 1) that is close to zero, such as, for example, a value of 0.1, a value of 0.01, or the like, depending on the domain of interest. This is because with small α, (i) for any arm i∈[k], the stationary distribution of its expected reward rᵢ(t) concentrates around zero with high probability; and (ii) observations of past rewards quickly deteriorate in their value of providing insights on the evolution of expected rewards in the future.

### Theorem 6.1

In the dynamic MAB problem, the naïve algorithm incurs per-round steady state regret at most

$$O ( \sqrt{log ( 1 / ασ ) + log k} \frac{ασ}{\sqrt{1 - {α}^{2}}} ) .$$

FIG. 2 is a graph illustrating a comparison of the order of the regret upper bound in Theorem 6.1 for the naive algorithm and the order of the lower bound in Theorem 4.1, in accordance with an example embodiment. The plot compares the two bounds with k=5, σ=0.2, C=0.4. (Similar plots can be obtained for different values of k and σ.) Observe that α̅ [symbol] 0.5 serves as a rough threshold value such that, when α∈(0, α̅), the orders of lower and upper bounds almost match with each other, which suggests limited room for improvement. (Nonetheless, it is shown elsewhere herein via numerical studies that the exemplary algorithm still outperforms the benchmark algorithms even when α is small.)

On the other hand, as α→1, the gap between the orders of lower and upper bounds start to expand, implying that the problem has become more difficult and the naive algorithm no longer produces satisfying performance. Focus below is therefore on the more challenging regime when the future is strongly correlated with the past (i.e., when α∈[α̅, 1)).

In Theorem 6.2, a regret upper bound for AR2 when α∈[α̅, 1) is established. Recall that if α is close to one, the regret lower bound can be characterized as Ω(kα²σ²). This shows that the exemplary algorithm is optimal in terms of AR parameter α and stochastic rate of change σ (up to logarithmic factors).

### Theorem 6.2

Let

$$𝒦 ( α ) {=}^{△} ⌊ \frac{1}{2} ( log ( \frac{1}{8} ) / log α + 1 ) ⌋ ,$$

and let A be the AR2 algorithm that gets restarted in each epoch of length Δₑₚ=└kα⁻³σ⁻³┘. If α∈[α̅, 1) and k≤K(α), the per-round steady state regret of A satisfies R̅E̅G̅_̅{̅A̅}̅≤0 (c₀²α²σ²k³ log(c₀ασ\sqrt{k})), where c₀=\sqrt{4 log(1/ασ)+4 log Δₑₚ+2 log(4k)}.

It is noted that, in terms of the dependency on k, Theorem 6.2 requires k≤K(α) mainly for analysis, and this bound loosens as a approaches one. (For example, when α=0.95, K(α)=20.) In particular, the bound K(α) results from the exemplary loose upper bound for the number of triggered arms in the proof of Lemma D.3, where the fact that there are at most k−1<K(α) triggered arms at any round is used to limit how quickly the values of the past observations diminish. If, at any given round, the number of triggered arms is O(1), the upper bound K(α) would no longer be required, and the regret upper bound can be further reduced to O(c₀²α²σ²k log(c₀ασ)), which essentially matches the lower bound (up to logarithmic factors). Theorem 6.2 is shown to well-characterize the performance of AR2 under different settings.

### 7 Proof of Theorem 6.2

The proof of Theorem 6.2 proceeds in four steps. In Step 1, a new notion called distributed regret is defined by distributing the instantaneous regret, incurred at the round the arm is pulled, over the few subsequent rounds. The per-round steady state regret is then rewritten in terms of distributed regrets. In Step 2, a high-probability good event that is critical for the exemplary analysis of the distributed regret is defined. In Step 3, an upper bound is provided for the distributed regret at each round, with the help of the important implications of the good event. In Step 4, the distributed regrets are summed over rounds and epochs, which establishes the per-round steady state regret of AR2 against the dynamic benchmark.

### Step 1: Distributed Regrets

Let Δrᵢ(t)=r*(t)−rᵢ(t) be the instantaneous regret incurred from pulling arm i at round t, where r*(t)=max_{i∈[k]}{rᵢ(t)} is the maximum expected reward at round t. Consider the expected per-round regret:

$$\overline{R E {G}_{A}} = 𝔼 [ \frac{1}{T} {\sum }_{t = 1}^{T} R E {G}_{A} ( t ) ] = \frac{1}{T} {\sum }_{t = 1}^{T} 𝔼 [ Δ {r}_{{I}_{t}} ( t ) ] \qquad ( 3 )$$

Here, Δr_{I}_{ₜ}(t)=r*(t)−r_{I}_{ₜ}(t) is the instantaneous regret incurred at round t. In the following, it is shown that this instantaneous regret can be distributed over subsequent rounds.

Note that, for any i∈[k], let Qᵢ^{(j)} denote the round at which arm i gets pulled for the j^{th} time within an epoch. Then, during the period between two consecutive pulls Qᵢ^{(j)}≤t≤Qᵢ^{(j+1)}, the only regret incurred from pulling arm i is the instantaneous regret Δrᵢ(Qᵢ^{(j)}). By previous definition, τᵢ(t)=Qᵢ^{(j)}, τᵢ^{next}(t)=Qᵢ^{(j+1)}, and Δτᵢ(t)=Qᵢ^{(j+1)}−Qᵢ^{(j)} for all Qᵢ^{(j)}≤t<Qᵢ^{(j+1)}. Observe that Δrᵢ(Qᵢ^{(j)}) can be decomposed as follows:

$$Δ {r}_{i} ( {Q}_{i}^{( j )} ) = {\sum }_{t = {Q}_{i}^{( j )}}^{{Q}_{i}^{( j + 1 )} - 1} ( \frac{Δ {r}_{i} ( {Q}_{i}^{( j )} ) {α}^{2 ( t - {Q}_{i}^{( j )} )}}{1 + {α}^{2} + … + {α}^{2 ( {Q}_{i}^{( j + 1 )} - 1 - {Q}_{i}^{( j )} )}} ) = {\sum }_{t = {Q}_{i}^{( j )}}^{{Q}_{i}^{( j + 1 )} - 1} ( \frac{Δ {r}_{i} ( {τ}_{i} ( t ) ) {α}^{2 ( t - {τ}_{i} ( t ) )}}{1 + {α}^{2} + … + {α}^{2 ( Δ {τ}_{i} ( t ) - 1 )}} )$$

This leads to the following notion of distributed regret:

### Definition 7.1 (Distributed Regret)

The distributed regret of arm i at round t is defined as:

$${D}_{i} ( t ) = ( \frac{Δ {r}_{i} ( {τ}_{i} ( t ) )}{1 + {α}^{2} + … + {α}^{2 ( Δ {τ}_{i} ( t ) - 1 )}} ) {α}^{2 ( t - {τ}_{i} ( t ) )} \qquad ( 4 )$$

Note that Dᵢ(t)=0 if arm i is the best arm at round τᵢ(t) (i.e., Δrᵢ(τᵢ(t))=0), and there is no regret to be distributed. Now, letting Tᵢ be the total number of rounds that arm i is pulled in the horizon, (3) can be rewritten to be:

$$\overline{{REG}_{A}} = \frac{1}{T} {\sum }_{i = 1}^{k} {\sum }_{j = 1}^{{T}_{i}} 𝔼 [ Δ {r}_{i} ( {Q}_{i}^{( j )} ) ] = \frac{1}{T} {\sum }_{i = 1}^{k} {\sum }_{t = 1}^{T} 𝔼 [ {D}_{i} ( t ) ]$$

In addition, recall that AR2 proceeds in epochs of length Δₑₚ, and S=T/Δₑₚ is the total number of epochs. The expected per-round regret can be further rewritten as:

$$\overline{R E {G}_{A}} = \frac{1}{T} {\sum }_{i = 1}^{k} {\sum }_{s = 1}^{S} {\sum }_{t = ( s - 1 ) {Δ}_{e p} + 1}^{S {Δ}_{e p}} 𝔼 [ {D}_{i} ( t ) ] \qquad ( 5 )$$

### Step 2: Good Event and its Implications

Before proceeding, a good event G(t) at round t is defined, which would help simplify the exemplary analysis. In principle, a good event G(t) is said to happen at round t if the noises within the epoch including t are not too large in magnitude. Recall from the section entitled “Dynamic MAB Problem with Stochastic Temporal Structure” that rᵢ(t) follows an AR-1 process with reflective boundaries: rᵢ(t+1)=B(α(rᵢ(t)+ϵᵢ(t))). Hence, a new noise term that shows the influence of reflective boundary needs to be defined:

$${\tilde{ϵ}}_{i} ( t ) = \{ \begin{matrix}{ϵ}_{i} ( t ) if α ( {r}_{i} ( t ) + {ϵ}_{i} ( t ) ) ∈ [ - R , R ] \\ \frac{1}{α} [ B ( α ( {r}_{i} ( t ) + {ϵ}_{i} ( t ) ) ) - α {r}_{i} ( t ) ] otherwise\end{matrix} \qquad ( 6 )$$

In particular, the new noise \tilde{ϵ}ᵢ(t) satisfies the following recursive relationship: rᵢ(t+1)=αrᵢ(t)+α\tilde{ϵ}ᵢ(t). The good event G(t), as defined, states that, for any sub-interval [t₀, t₁] within the epoch (including t), the weighted sum of \tilde{ϵ}ᵢ(t) satisfies a concentration inequality.

### Definition 7.2 (Good Event at Round t)

The good event G(t) is said to occur at round t if, for every i∈[k] and for every sub-interval [t₀, t₁], where t−Δₑₚ≤t₀<t₁≤t+Δₑₚ, the weighted sum of the noises \tilde{ϵ}ᵢ(t) satisfies:

$$\vert {\sum }_{t = {t}_{0}}^{{t}_{1} - 1} {α}^{{t}_{1} - t} {\tilde{ϵ}}_{i} ( t ) \vert < {c}_{0} σ \sqrt{( {α}^{2} - {α}^{2 ( {t}_{0} - {t}_{1} + 1 )} ) / ( 1 - {α}^{2} )} , \qquad ( 7 )$$

$$where {c}_{0} = \sqrt{4 log ( 1 / ασ ) + 4 log ( {Δ}_{e p} ) + 2 log ( 4 k )}$$

By building a connection between \tilde{ϵ}ᵢ(t) and ϵᵢ(t) and Hoeffding's inequality, Lemma 7.3 is shown, which confirms that the good event G(t) happens with high probability.

### Lemma 7.3

For any t∈[T], [symbol] [G^{c}(t)]≤(ασ)². The good event G(t) comes with three pertinent implications. If G(t) occurs, (i) the exemplary estimated reward \hat{r}ᵢ(t) does not deviate too much from the true expected reward rᵢ(t); (ii) AR2 does not wait too long to play an arm with high expected reward; and (iii) the best expected reward r*(t) would not be too far away from the exemplary estimated reward for the superior arm \hat{r}ₛᵤₚ(t). With the help of these implications, the exemplary analysis of the distributed regret Dᵢ(t) is greatly simplified.

### Step 3: Distributed Regret Analysis

For a given round t in the s-th epoch, its expected distributed regret [symbol] [Dᵢ(t)] can be bound by first decomposing it into two terms:

$$𝔼 [ {D}_{i} ( t ) ] = 𝔼 [ {D}_{i} ( t ) {{G}^{c} ( t )}_{} ] + 𝔼 [ {D}_{i} ( t ) {G ( t )}_{} ] ,$$

where [symbol] _{ε} is the indicator function of event E. The first term can be bound by applying Lemma 7.3:

$$𝔼 [ {D}_{i} ( t ) {{G}^{c} ( t )}_{} ] \leq 2 R \cdot ℙ [ {G}^{c} ( t ) ] \leq 2 R \cdot {( ασ )}^{2} = O ( {σ}^{2} {α}^{2} ) \qquad ( 8 )$$

To bound the second term, the implications of the good event G(t) are relied on to show the following.

### Lemma 7.4

Suppose that AR2 is applied to the dynamic MAB problem with α∈[α̅, 1) and k≤K(α), for every arm i∈[k] and some round τᵢ(t)≤t<τᵢ^{next}(t), where τᵢ(t) and τᵢ^{next}(t) are two consecutive rounds at which i gets pulled, then:

$$𝔼 [ {D}_{i} ( t ) {G ( t )}_{} ] \leq O ( {c}_{0}^{2} {α}^{2} {σ}^{2} {k}^{2} log ( {c}_{0} σ α \sqrt{k} ) ) \qquad ( 9 )$$

The bound of the second term is defined by:

$$\begin{matrix}𝔼 [ {D}_{i} ( t ) {G ( t )}_{} {\{ 0 < Δ {r}_{i} ( t ) \leq \tilde{C} \}}_{} ] ≲ \tilde{C} \cdot ℙ [ 0 < Δ {r}_{i} ( t ) \leq \tilde{C} ] \\ \leq \tilde{C} \cdot O ( \tilde{C} ) \\ = O ( {\tilde{C}}^{2} ) = O ( {c}_{0}^{2} {α}^{2} {σ}^{2} k )\end{matrix} \qquad ( 9 A )$$

Thus, it will be appreciated that a bound for the nominator and denominator of Dᵢ(t) respectively is provided, conditioning on the good event G(t) and the value of Δrᵢ(t), and the three implications stated in Step 2 are employed. Now, combining equations (8) and (9), for any round t within the s^{th} epoch such that τᵢ(t)≤t<τᵢ^{next}(t):

$$𝔼 [ {D}_{i} ( t ) ] = 𝔼 [ {D}_{i} ( t ) {{G}^{c} ( t )}_{} ] = 𝔼 [ {D}_{i} ( t ) {G ( t )}_{} ] \leq O ( {c}_{0}^{2} {σ}^{2} {α}^{2} {k}^{2} log ( {c}_{0} σ α \sqrt{k} ) ) \qquad ( 10 )$$

### Step 4: Summing the Distributed Regrets

Given Equations (5), (10) and Δₑₚ=[kα⁻³σ⁻³], summing the expected distributed regrets first within an epoch, and then along the horizon yields

$$\overline{{REG}_{A}} = \frac{1}{T} {\sum }_{i = 1}^{k} {\sum }_{s = 1}^{S} {\sum }_{t = ( s - 1 ) {Δ}_{ep} + 1}^{s {Δ}_{ep}} 𝔼 [ {D}_{i} ( t ) ] \leq \frac{1}{T} {\sum }_{i = 1}^{k} S \cdot [ O ( {\tilde{C}}^{2} log ( \tilde{C} ) ) {Δ}_{ep} + 2 R ] = O ( k {\tilde{C}}^{2} log ( \tilde{C} ) )$$

where the additional two term comes from the initialization round and the last round arm i is pulled within an epoch. This concludes the proof if in \tilde{C}=c₀ασ\sqrt{k} is plugged in.

### Extension on Learning the AR Parameter

In the embodiments above, full knowledge of the AR parameter is assumed when there is access to past data. In another aspect, the algorithm is extended for situations when the AR parameter needs estimation. A maximum likelihood method is introduced and the performance of AR2 is numerically evaluated, which show that AR2 still remains competitive despite noise in the estimated AR parameter.

### A Maximum Likelihood Estimator

If the decision maker does not have prior knowledge of the AR parameter α, the AR parameter can be learned via Maximum Likelihood Estimation (MLE). In the first Tₑₛₜ rounds of the time horizon, where Tₑₛₜ=O(T^{β}) for some β∈(0, 1), one arm i∈[k] is pulled consecutively for a fixed arm i and rewards Rᵢ(1), . . . , Rᵢ(Tₑₛₜ) are observed. The maximum likelihood estimator is defined as \hat{α}=argmin_{α∈(0,1)} [symbol] (α), where [symbol] (α) is the negative of the log-likelihood function defined in (11) below. It is observed that linear regression cannot be directly applied for estimating α because the existence of truncating boundaries would lead to a biased estimator. MLE, on the other hand, remains robust even when the expected reward of the exemplary arm hits the boundary. Since the number of rounds used for estimation Tₑₛₜ scales sublinearly with T, the regret incurred within the first Tₑₛₜ rounds would not impact the exemplary per-round regret upper bound. If the arms i∈[k] have heterogeneous AR parameters αᵢ, each arm i∈[k] can simply be pulled consecutively for Tₑₛₜ rounds and MLE performed for each αᵢ. The following proposition quantifies the amount of noise in the estimated AR parameter.

Since arm i is pulled consecutively for Tₑₛₜ rounds for some fixed arm i∈[k], the dependency of Rᵢ(t) on i is omitted here and Rₜ [symbol] Rᵢ(t) is denoted. Let the loss function [symbol] (α) stated in the optimization problem first be defined:

$$\hat{α} = arg {min}_{α ∈ ( 0 , 1 )} ℒ ( α )$$

which is the negative of the log-likelihood function:

$$ℒ ( α ) = - \frac{1}{{T}_{est}} {\sum }_{t = 1}^{{T}_{est}} 𝕀 \{ {R}_{t} = ℛ \} log [ 1 - Φ ( \frac{ℛ - α {R}_{t - 1}}{σ} ) ] + 𝕀 \{ {R}_{t} = - ℛ \} log [ Φ ( \frac{- ℛ - α {R}_{t - 1}}{σ} ) ] + 𝕀 \{ - ℛ < {R}_{t} < ℛ \} log [ Φ ( \frac{ℛ - α {R}_{t - 1}}{σ} ) - Φ ( \frac{- ℛ - α {R}_{t - 1}}{σ} ) ] , \qquad ( 11 )$$

where Φ(.) is the CDF of standard normal distribution. Note that the three terms in the loss function respectively represent the log likelihood of the observed reward at the upper boundary, at the lower boundary and in between the boundaries.

### Proposition 8.1

Let \hat{α}=argmin_{α∈(0,1)} [symbol] (α) be the estimated AR parameter. Then, for γ>0, with probability at least 1−2/Tₑₛₜ^{γ}−2exp(−TₑₛₜV²/2 [symbol] ²), there exists constants L₁, L₂ such that |\hat{α}−α|≤(4σ [symbol] L₁)/(VL₂)·\sqrt{2γ log Tₑₛₜ/Tₑₛₜ}, where V is the variance of the observed reward in the stationary distribution, which is independent of the exemplary algorithm or the time horizon T.

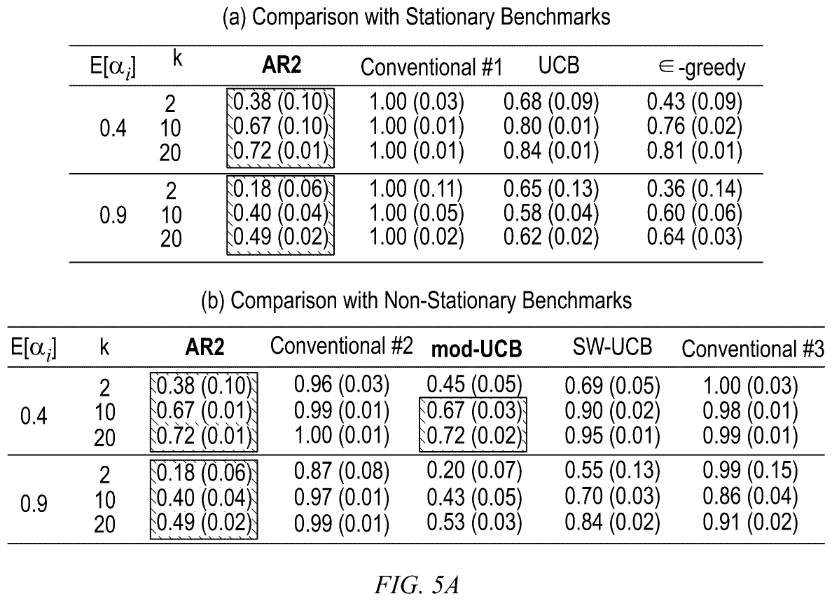

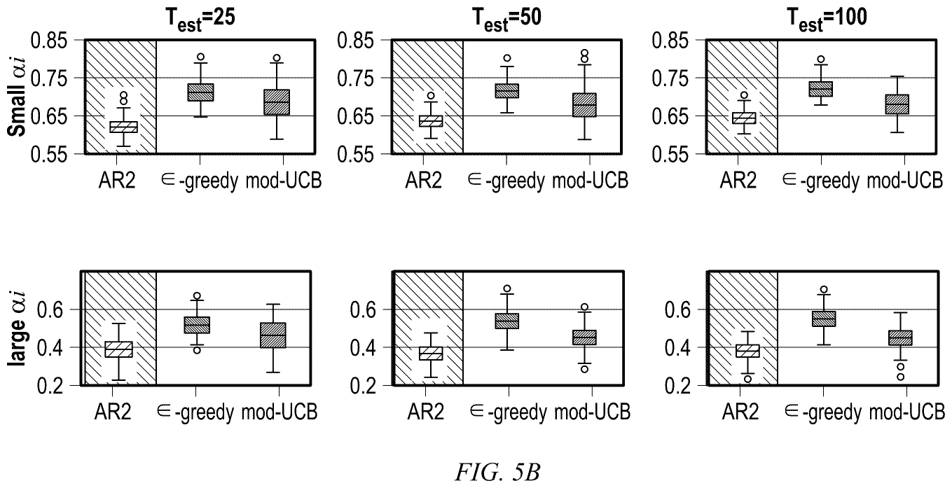

The normalized regret incurred by AR2, ϵ-greedy and mod-UCB are plotted using the estimated AR parameters, obtained through MLE with Tₑₛₜ={25, 50, 100}. It is observed that whenever the AR parameters αᵢ are small or large, the performance of AR2 outcompetes the other two benchmarks. In particular, AR2 appears to be robust to the noises in the estimated AR parameter, with performance close to what would otherwise be obtained with the accurate AR parameters (see table of FIG. 5A). FIG. 5A is a table of the mean and standard deviation (in parenthesis) of normalized regret incurred by each algorithm at T=10,000, in accordance with an example embodiment. All experiments were run with 100 instances. The algorithm with the smallest normalized regret is highlighted by the crosshatch pattern.

FIG. 5B illustrates box plots of normalized regret incurred by each algorithm at T=10,000 (AR2 highlighted with crosshatch pattern), in accordance with an example embodiment. The input AR parameter \hat{α}ᵢ is the maximum-likelihood estimator of the true AR parameter. The magnitudes of AR parameters E[αᵢ]∈{0.4, 0.9} and the number of rounds used for estimation_Tₑₛₜ∈{25, 50, 100} are varied. The parameters of the disclosed instances are the same as defined immediately below, and k=6 is taken.

A dynamic bandit problem with k arms and T=10,000 rounds was considered. To make the setting more general, the expected reward rᵢ(t) of each arm i∈[k] is let to follow an independent AR-1 process with heterogeneous AR parameter αᵢ, stochastic rate of change σᵢ, and truncating boundary [−1, 1]. Two different regimes of αᵢs were considered: (i) Small αᵢs: the AR-1 parameters {αᵢ}ᵢ₌₁^{k} are drawn from a Dirichlet distribution with rescaling such that for all i∈[k], [symbol] [αᵢ]=0.4, which is less than the threshold value α̅=0.5. (ii) Large αᵢs: the AR-1 parameters {αᵢ}ᵢ₌₁^{k} are chosen from a Dirichlet distribution with rescaling such that [symbol] [αᵢ]=0.9 for all i∈[k]. The concentration parameters of the Dirichlet distributions are all set to be 5. For each regime of αᵢs (small vs. large), 100 instances were considered, where each instance corresponds to AR parameters (α₁, . . . , αₖ) generated as described above; and stochastic rates of change (σ₁, . . . , σₖ) generated from i.i.d. uniform distributions in (0, 0.5). The initial reward rᵢ(0) is drawn independently from the stationary distribution.

### Implementation of AR2

To apply AR2 to the more general setting described immediately above, where the expected reward of each arm i undergoes an AR-1 process with heterogeneous AR parameter αᵢ and stochastic rate of change or, a few updates are made to AR2: (i) when maintaining estimated reward \hat{r}ᵢ(t) of arm i, its AR parameter αᵢ is used; (ii) it is assumed that an arm i≠iₛᵤₚ(t) gets triggered if, at round t,

$${\hat{r}}_{sup} ( t ) - {\hat{r}}_{i} ( t ) \leq {c}_{1} {σ}_{i} \sqrt{( {α}_{i}^{2} - {α}_{i}^{2 ( t - {τ}_{i} + 1 )} ) / ( 1 - {α}_{i}^{2} )} .$$

Empirically, two changes to AR2 are made in its numerical implementation. (i) The definition of the superior arm: instead of one of the two most recently pulled arms, all arms are considered and the one with the highest estimated reward at round t is chosen to be the superior arm at round t, i.e., iₛᵤₚ(t)=arg max_{i∈[k]}\hat{r}ᵢ(t). (ii) The triggered arm to be played: in the exploration round t (when t is odd and [symbol] ≠Ø), the upper confidence bound of the expected reward of each arm i is considered, defined as:

$${UCB}_{i} ( t ) = {\hat{r}}_{i} ( t ) + {c}_{1} {σ}_{i} \sqrt{( {α}_{i}^{2} - {α}_{i}^{2 ( t - {τ}_{i} ( t ) )} ) / ( 1 - {α}_{i}^{2} )}$$

and the triggered arm with the highest upper confidence bound (UCB) is pulled, i.e. Iₜ=arg [symbol] UCBⱼ(t). Note that the arms in the triggered set [symbol] differ in terms of both triggering time and estimated rewards. Previously, exemplary criteria for selecting the triggered arm to play only take into account one aspect of such heterogeneity, i.e., the triggering time. The new criteria allows to also consider the estimated reward of each arm, which is another indicator of the arm's potential.
Extension of AR2 to AR-p Process with Trend

FIG. 4B is a second example alternating and restarting (AR) algorithm for dynamic AR bandits, in accordance with an example embodiment. An extension of the AR2 (Algorithm 1) is provided, which applies to non-stationary bandits where the rewards follow general AR-p processes with trends for any p≥1. This algorithm is applied when the exemplary case study is performed; for example, on the tourism demand prediction in the section entitled “Proof of Theorem 6.2”, and is shown to adapt well to the more complex, rapidly evolving environment.

Assume that, for each arm i∈[k], the reward distribution follows an AR-p process, potentially with a trend component. That is, conditioning on past history during rounds t−1, . . . , 1, the expected reward of arm i at round t is

$${r}_{i} ( t ) = {α}_{i , 0} + {\sum }_{j = 1}^{p} {α}_{i , j} {R}_{i} ( t - j ) ,$$

where α_{i,0} is the trend component and (α_{i,1}, . . . , α_{i,p}) is the set of AR parameters associated with arm i.

The details of the extension of AR2 is presented in Algorithm 2, which is called AR2-p herein. At a high level, the main techniques used in AR2-p are similar to those used in AR2. However, since AR2-p is advantageously able to address practical scenarios where real-world dynamics are represented by more complex time series, the implementation changes discussed above are incorporated to enhance its practical applicability, so that there are significant differences from AR2.

At each round t of Algorithm 2, the superior arm iₛᵤₚ(t) is first determined, which is the arm with the highest expected reward. A decision is then made of whether there are any arms to trigger, depending on whether some untriggered arm has an upper confidence bound that exceeds the expected reward of the superior arm fₛᵤₚ(t). Exploration and exploitation are then alternated between: (i) during exploitation rounds, the superior arm is pulled; (ii) during exploration rounds, the arm with the highest upper confidence bound out of the set of triggered arms, denoted as [symbol] , is pulled. Finally, after arm Iₜ is pulled at each round, the estimate for the state of each arm i∈[k] is updated.

A significant difference between AR2-p and AR2 for AR-1 process lies in how estimates for each arm are maintained. To account for the more complicated structure of an AR-p process with trends, two estimates need to be maintained for each arm—an estimate for the expected reward \hat{r}ᵢ(t), and an estimate for the error bound Êᵢ(t), defined as follows:

$${\hat{r}}_{i} ( t ) = {α}_{i , 0} + {\sum }_{j = 1}^{p} {α}_{i , j} {\hat{r}}_{i} ( t - j ) and {\hat{E}}_{i} ( t ) = {\sum }_{j = 1}^{p} {α}_{i , j} {\hat{E}}_{i} ( t - j ) + {α}_{i , j} .$$

Here, the estimate for error bound Êᵢ(t) essentially captures how much error is contained in the exemplary estimate for arm i at round t, i.e., \hat{r}ᵢ(t). Since \hat{r}ᵢ(t) is estimated based on p past estimates \hat{r}ᵢ(t−1), . . . , \hat{r}ᵢ(t−p), the error associated with each of these terms, i.e., Êᵢ(t−1), . . . , Eᵢ(t−p), contributes the total error for arm i at round t, i.e., Êᵢ(t).

The error estimate Êᵢ(t) can then be used in determining the triggering condition. An arm i∉ [symbol] ∪{iₛᵤₚ(t)} is triggered at round t if

$${\hat{r}}_{sup} ( t ) - {\hat{r}}_{i} ( t ) \leq c {σ}_{i} \sqrt{{\hat{E}}_{i} ( t )} .$$

The error bound estimates are also useful when it is determined which arm to pull out of all the triggering arms. To do that, the upper confidence bound is formed for each arm

$${UCB}_{i} ( t ) = {\hat{r}}_{i} ( t ) + c {σ}_{i} \sqrt{{\hat{E}}_{i} ( t )}$$

and the one with the highest upper confidence bound is picked: Iₜ=arg ma [symbol] UCBᵢ(t).

### 8 Numerical Studies

Numerical studies that compare the performance of AR2 against a number of benchmarks designed for both stationary and non-stationary settings were performed and are described below.

### Implementation of AR2

To apply AR2 to the more general setting described in the section entitled “Numerical Studies”, where the expected reward of each arm i undergoes an AR-1 process with heterogeneous AR parameter αᵢ and stochastic rate of change σᵢ, a few straightforward updates to AR2 are made: (i) when maintaining the estimated reward \hat{r}ᵢ(t) of arm i, its AR parameter αᵢ is used; and (ii) the triggering criteria is modified to be that in round t. It is assumed that an arm i≠iₛᵤₚ(t) gets triggered if

$${\hat{r}}_{sup} ( t ) - {\hat{r}}_{i} ( t ) \leq {c}_{1} {σ}_{i} \sqrt{( {α}_{i}^{2} - {α}_{i}^{2 ( t - {τ}_{i} + 1 )} ) / ( 1 - {α}_{i}^{2} )} .$$

Empirically, two more minor changes are made to AR2 in its numerical implementation: (i) the definition of the superior arm (instead of considering one of the two most recently pulled arms, all arms are considered and the one with the highest estimated reward at round t is chosen to be the superior arm at round t, i.e., iₛᵤₚ(t)=arg max_{i∈[k]}\hat{r}ᵢ(t)); and (ii) the triggered arm to be played (in the exploration round t when t is odd and T≠Ø), the upper confidence bound of the expected reward of each arm i is considered, defined as:

$${UCB}_{i} ( t ) = {\hat{r}}_{i} ( t ) + {c}_{1} {σ}_{i} \sqrt{( {α}_{i}^{2} - {α}_{i}^{2 ( t - {τ}_{i} ( t ) )} ) / ( 1 - {α}_{i}^{2} )} .$$

and pull the triggered arm with the highest upper confidence bound, i.e. Iₜ=arg max_{j∈T}UCBᵢ(t). Note that the arms in the triggered set T differ in terms of both triggering time and estimated rewards. Previously, the exemplary criteria for selecting the triggered arm to play only takes into account one aspect of such heterogeneity, i.e., the triggering time. The new criteria allows the consideration of the estimated reward of each arm, which is another indicator of the arm's potential.

### Set-Up

A dynamic bandit problem with k arms and T=10,000 rounds is considered. To make the setting more general, the expected reward rᵢ(t) of each arm i∈[k] is set to follow an independent AR-1 process with heterogeneous AR parameter αᵢ, stochastic rate of change σᵢ, and reflective boundary [−1, 1]. Two different regimes of αi's are considered: (i) small αᵢ's: the AR-1 parameters {αᵢ}ᵢ₌₁^{k} are drawn from a Dirichlet distribution with rescaling such that for all i∈[k], [symbol] [αᵢ]=0.4, which is less than the threshold value α̅=0.5 that is defined in the section entitled “Regret of Algorithm AR2”; and (ii) large αᵢ's: the AR-1 parameters {αᵢ}ᵢ₌₁^{k} are chosen from a Dirichlet distribution with rescaling, such that for all i∈[k]. The concentration parameters of the Dirichlet distributions are all set to be 5. For each regime of αᵢ's (small vs. large), 100 instances are considered, where each instance corresponds to AR parameters (a1, . . . , ak) generated as described above; and stochastic rates of change (α₁, . . . , αₖ) generated from i.i.d. (Independent and Identically Distributed) uniform distributions in (0, 0.5). The initial reward rᵢ(0) is drawn independently from the stationary distribution defined in the section entitled “Stationary Distributions of Rewards”. In the following experiments, there is full knowledge of the AR parameters.

### Performance Comparison

AR2 was implemented and compared against five benchmarks. See section entitled “Implementation of AR2” for the implementation details, where AR2 is generalized to the setting with heterogeneous αᵢ's and σᵢ's. The benchmark algorithms that were considered are: (i) a first benchmark policy that first selects each arm for m rounds, and commits to the arm with the highest average pay-off in the remaining T−mk rounds; (ii) a second benchmark for nonstationary bandits, where the total variation of expected rewards is bounded by a variation budget VT; (iii) a third benchmark with probability of exploration ϵ=0.1, which acts greedily with probability (1−ϵ) and explores a random arm otherwise; (iv) a fourth benchmark, which achieves sublinear regret when reward distributions are stationary; and (v) a fifth benchmark which is a modified form of the fourth benchmark and which modifies the upper confidence bound based on the structure of the AR-1 process. All parameters used in the algorithms are tuned.

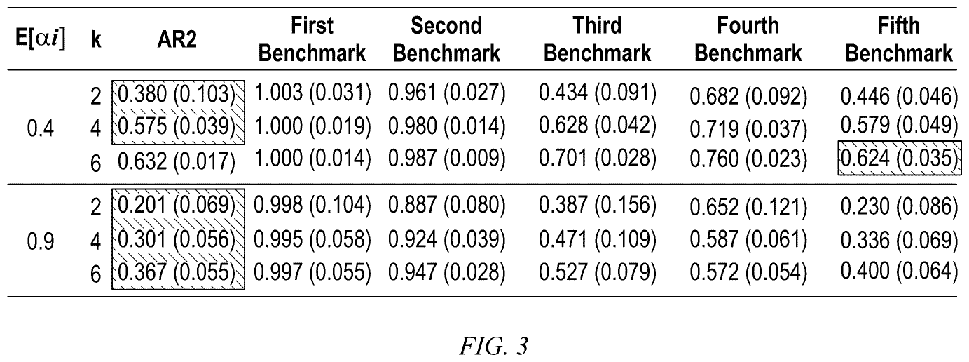

FIG. 3 is a table illustrating the performance of AR2 compared against benchmark algorithms in both instances with small αᵢ's ( [symbol] [αᵢ]=0.4) and large αᵢ's ( [symbol] [αᵢ]=0.9), in accordance with an example embodiment. The number of arms k∈{2, 4, 6} was also varied. To keep the results consistent across instances, each algorithm A was evaluated using the normalized regret: Σₜ₌₁^{T}REG_{A}(t)/Σₜ₌₁^{T}r*(t), which normalizes the total regret using the reward of optimal in hindsight dynamic policy. (Note that since the expected rewards can be negative, the normalized regret can exceed one. Further, when αᵢ's are small, the normalized regret of each algorithm is in general larger. This is because the optimal reward used in normalization tends to be smaller, and hence does not contradict the fact that the exemplary problem is more challenging when the AR parameters are small.) From the table of FIG. 3, it is seen that AR2 clearly outperforms the benchmarks in almost all choices of k and regimes of αᵢ's. The algorithms designed for stationary settings (Conventional #1, UCB) and for non-stationary environments with sublinear changes (Conventional #2) perform poorly, as the AR setting substantially differs from the settings they were intended for. In comparison with benchmarks that take into account the AR structure of rewards (ϵ-greedy and modified UCB), AR2 also displays superior performance. There are instances where AR2 can contribute to a decrease in regret as high as 48% when compared to ϵ-greedy, and a 14.7% decrease in regret when compared to modified UCB. These results demonstrate the unique strength of AR2 when dealing with a fast-changing, non-stationary environment introduced by the AR temporal structure, which differentiates it from different types of benchmarks.

One or more embodiments provide an exploration strategy that deals with two phases; exploiting an arm that is expected to yield high reward, and exploring arms with high potential. A second trade-off includes remembering and forgetting and discarding past information that becomes misleading. Given the discussion thus far, it will be appreciated that, in general terms, an exemplary method, according to an aspect of the invention, includes the operations of obtaining, using at least one hardware processor, the multi-armed bandit (MAB) problem; determining, using the at least one hardware processor, a per-round regret lower bound, wherein a corresponding regret is measured against a benchmark; and providing, using the at least one hardware processor, the multi-armed bandit problem to an algorithm that has a per-round regret that is close to the determined per-round regret lower bound, wherein the algorithm dynamically adapts to changes and discards irrelevant past information by: alternating, using the at least one hardware processor, between recently pulled arms and unpulled arms having potential, wherein the alternating comprises updating an estimate of an expected reward of each arm within each epoch and an estimate for an error bound that captures an amount of error contained in the estimate of the expected reward for each arm within each epoch based on the auto-regressive temporal structure with trend components, and restarting, using the at least one hardware processor, the algorithm.

In one example embodiment, the restarting is performed after one epoch of the algorithm is concluded.

In one example embodiment, the restarting the algorithm further comprises discarding reward estimates that were maintained for each arm and emptying a set of triggered arms to create revised reward estimates of expected rewards for each arm.

In one example embodiment, the restarting the algorithm further comprises examining arms that are not necessarily triggered but have a potential to surpass triggered arms in terms of reward.

In one example embodiment, the determined per-round regret lower bound is characterized as a function of a stochastic rate of change σ and a temporal correlation of rewards α.

In one example embodiment, packets in a network are adaptively routed based on results of the alternating operation.

In one example embodiment, in the obtaining operation, the multi-armed bandit problem is defined as an adaptive routing of a plurality of packets in a network; each arm corresponds to a route through the network; and the expected reward is related to a throughput of a corresponding route through the network. Furthermore, the regret lower bound is a highest throughput that the method can attain for the corresponding network route and a given round; the discarding of the irrelevant past information includes discarding outdated throughput performance information that was collected for the corresponding network route; the amount of error contained in the estimate of the expected reward for each arm is an amount of error contained in an estimate of an expected throughput for each arm. Yet further, the alternating operation alternates between recently considered network routes and unexplored network routes; the restarting of the algorithm further includes resetting the estimate of the expected throughput for each arm; and the method further includes adaptively routing the plurality of packets in the network based on results of the alternating operation. It is noted that, in the network routing example, the regret is the difference between the throughput being attained and the throughput obtained in the benchmark and that, when the environment is time-varying, the per round regret is not expected to go to zero as the number of rounds goes to zero. Also, if the throughput of a given route was classified as good in a given round, the throughput of the given route is expected to be classified as good in a next round.

In one example embodiment, an expected reward rᵢ(t) follows an independent AR-1 process with reflective boundaries [−R, R].

In one example embodiment, the alternating between recently pulled arms and unpulled arms with potential further comprises selecting a superior arm expected to have a higher reward than expected rewards of other competing arms based on recently collected information.

In one example embodiment, the alternating between recently pulled arms and unpulled arms with potential further comprises selecting a triggered arm of a set of triggered arms that has a potential to outperform a superior arm.

In one example embodiment, all arms have a heterogeneous temporal correlation of rewards α_{i,j} and have heterogeneous stochastic rates of change σ_{i,j}.

In one example embodiment, temporal correlation of the rewards α_{i,j} is estimated using the maximum likelihood estimator.

In one example embodiment, for any fixed stochastic rate of change σ∈(0, 1), a stationary distribution of a given expected reward rᵢ(t) is approximated by a uniform distribution when a corresponding temporal correlation of rewards α approaches a value of one from a given threshold and the stationary distribution of the given expected reward rᵢ(t) is approximated by a normal distribution when the corresponding temporal correlation of rewards α approaches a value of zero from the given threshold. The skilled artisan will appreciate that, given the teachings herein, the given threshold may be selected heuristically. In one non-limiting example embodiment, the given threshold is set to 0.5. The skilled person can determine when a parameter approaches zero or one based on the change over time.

In one example embodiment, the unpulled arms having potential are arms pulled within a given number of rounds and an arm i≠iₛᵤₚₑᵣᵢₒᵣ(t) gets triggered in a round t if triggering criteria is satisfied, wherein the triggering criteria is defined as \hat{r}ₛᵤₚ(t)−\hat{r}ᵢ(t)≤cσᵢ\sqrt{Êᵢ(t)} where σ is a stochastic rate of change and α is a temporal correlation of rewards, c₁ depends on the stochastic rate of change and the temporal correlation of rewards and Êᵢ(t)−Σⱼ₌₁^{p}α_{i,j}î(t−j)+α_{i,j}.

In one example embodiment, the alternating operation further comprises pulling each arm and setting corresponding reward estimates and updating an identity of a superior arm and a corresponding estimated reward; and the method further comprises receiving a reward in response to the alternating operation.

In one aspect, a computer program product comprises one or more tangible computer-readable storage media and program instructions stored on at least one of the one or more tangible computer-readable storage media, the program instructions executable by a processor, the program instructions comprising obtaining the multi-armed bandit (MAB) problem; determining a per-round regret lower bound, wherein a corresponding regret is measured against a benchmark; and providing the multi-armed bandit problem to an algorithm that has a per-round regret that is close to the determined per-round regret lower bound, wherein the algorithm dynamically adapts to changes and discards irrelevant past information by: alternating between recently pulled arms and unpulled arms having potential, wherein the alternating comprises updating an estimate of an expected reward of each arm within each epoch and an estimate for an error bound that captures an amount of error contained in the estimate of the expected reward for each arm within each epoch based on an auto-regressive temporal structure with trend components; and restarting the algorithm.

In one aspect, an apparatus comprises a memory and at least one processor, coupled to the memory, and operative to perform operations comprising obtaining the multi-armed bandit (MAB) problem; determining a per-round regret lower bound, wherein a corresponding regret is measured against a benchmark; and providing the multi-armed bandit problem to an algorithm that has a per-round regret that is close to the determined per-round regret lower bound, wherein the algorithm dynamically adapts to changes and discards irrelevant past information by: alternating between recently pulled arms and unpulled arms having potential, wherein the alternating comprises updating an estimate of an expected reward of each arm within each epoch and an estimate for an error bound that captures an amount of error contained in the estimate of the expected reward for each arm within each epoch based on an auto-regressive temporal structure with trend components; and restarting the algorithm.

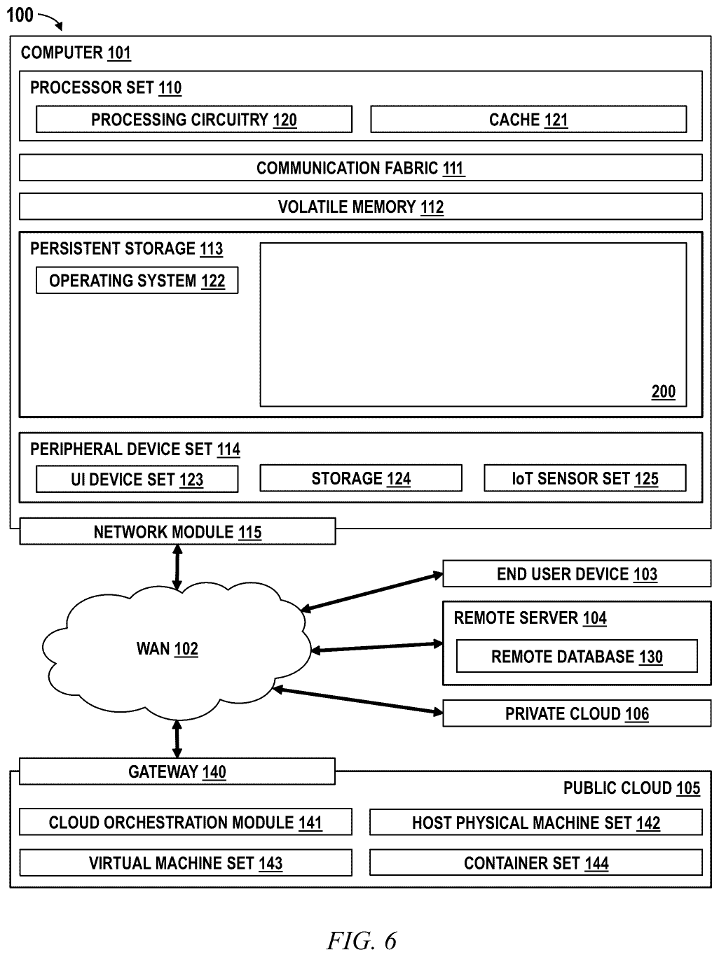

Refer now to FIG. 6. It will be appreciated that aspects of the invention can be used for a variety of practical applications, such as adaptively routing packets in a network such as 102 based on results of the alternating operation, online advertising, online auctions, demand forecasting, online recommendation systems, and dynamic pricing. Regarding demand forecasting, in a non-limiting example, demand for cloud resources can be forecast on computer 101, cloud resources can be deployed on clouds 105 and/or 106 (for example, based on signals sent over WAN 102), and either or both of the clouds 105, 106 can be operated in accordance with the deployed resources.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as bandit system 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 6. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of solving a multi-armed bandit problem with a general auto-regressive temporal structure with trend components, the method comprising:
obtaining, using at least one hardware processor, the multi-armed bandit (MAB) problem;
determining, using the at least one hardware processor, a per-round regret lower bound, wherein a corresponding regret is measured against a benchmark; and
providing, using the at least one hardware processor, the multi-armed bandit problem to an algorithm that has a per-round regret that is close to the determined per-round regret lower bound, wherein the algorithm dynamically adapts to changes and discards irrelevant past information by:
alternating, using the at least one hardware processor, between recently pulled arms and unpulled arms having potential, wherein the alternating comprises updating an estimate of an expected reward of each arm within each epoch and an estimate for an error bound that captures an amount of error contained in the estimate of the expected reward for each arm within each epoch based on the auto-regressive temporal structure with trend components; and
restarting, using the at least one hardware processor, the algorithm.

2. The method of claim 1, wherein the restarting is performed after one epoch of the algorithm is concluded.

3. The method of claim 2, wherein the restarting the algorithm further comprises discarding reward estimates that were maintained for each arm and emptying a set of triggered arms to create revised reward estimates of expected rewards for each arm.

4. The method of claim 2, wherein the restarting the algorithm further comprises examining arms that are not necessarily triggered but have a potential to surpass triggered arms in terms of reward.

5. The method of claim 1, wherein the determined per-round regret lower bound is characterized as a function of a stochastic rate of change σ and a temporal correlation of rewards α.

6. The method of claim 1, wherein:
in the obtaining operation, the multi-armed bandit problem is defined as an adaptive routing of a plurality of packets in a network;
each arm corresponds to a route through the network;
the expected reward is related to a throughput of a corresponding route through the network;
the regret lower bound is a highest throughput that the method can attain for the corresponding network route and a given round;
the discarding of the irrelevant past information comprises discarding outdated throughput performance information that was collected for the corresponding network route;
the amount of error contained in the estimate of the expected reward for each arm is an amount of error contained in an estimate of an expected throughput for each arm;
the alternating operation alternates between recently considered network routes and unexplored network route; and
the restarting of the algorithm further comprises resetting the estimate of the expected throughput for each arm;
further comprising adaptively routing the plurality of packets in the network based on results of the alternating operation.

7. The method of claim 1, wherein the alternating between recently pulled arms and unpulled arms with potential further comprises selecting a superior arm expected to have a higher reward than expected rewards of other competing arms based on recently collected information.

8. The method of claim 1, wherein the alternating between recently pulled arms and unpulled arms with potential further comprises selecting a triggered arm of a set of triggered arms that has a potential to outperform a superior arm.

9. The method of claim 1, wherein all arms have a heterogeneous temporal correlation of rewards α_{i,j} and have heterogeneous stochastic rates of change σ_{i,j}.

10. The method of claim 1, further comprising estimating temporal correlation of the rewards α_{i,j} using the maximum likelihood estimator.

11. The method of claim 1, wherein, for any fixed stochastic rate of change σ∈(0, 1), a stationary distribution of a given expected reward rᵢ(t) is approximated by a uniform distribution when a corresponding temporal correlation of rewards α approaches a value of one from a given threshold and the stationary distribution of the given expected reward rᵢ(t) is approximated by a normal distribution when the corresponding temporal correlation of rewards α approaches a value of zero from the given threshold.

12. The method of claim 1, wherein the unpulled arms having potential are arms pulled within a given number of rounds and an arm i≠iₛᵤₚₑᵣᵢₒᵣ(t) gets triggered in a round t if triggering criteria is satisfied, wherein the triggering criteria is defined as \hat{r}ₛᵤₚ(t)−\hat{r}ᵢ(t)≤cσᵢ\sqrt{Êᵢ(t)} where σ is a stochastic rate of change and α is a temporal correlation of rewards, c depends on the stochastic rate of change and the temporal correlation of rewards and Êᵢ(t)−Σⱼ₌₁^{p}α_{i,j}Êᵢ(t−j)+α_{i,j}.

13. The method of claim 1,
wherein the alternating operation further comprises pulling each arm and setting corresponding reward estimates and updating an identity of a superior arm and a corresponding estimated reward; and the method further comprises receiving a reward in response to the alternating operation.

14. A computer program product, comprising:
one or more tangible computer-readable storage media and program instructions stored on at least one of the one or more tangible computer-readable storage media, the program instructions executable by a processor, the program instructions comprising:
obtaining the multi-armed bandit (MAB) problem;
determining a per-round regret lower bound, wherein a corresponding regret is measured against a benchmark; and
providing the multi-armed bandit problem to an algorithm that has a per-round regret that is close to the determined per-round regret lower bound, wherein the algorithm dynamically adapts to changes and discards irrelevant past information by:
alternating between recently pulled arms and unpulled arms having potential, wherein the alternating comprises updating an estimate of an expected reward of each arm within each epoch and an estimate for an error bound that captures an amount of error contained in the estimate of the expected reward for each arm within each epoch based on an auto-regressive temporal structure with trend components; and
restarting the algorithm.

15. A system comprising:
a memory; and
at least one processor, coupled to said memory, and operative to perform operations comprising:
obtaining the multi-armed bandit (MAB) problem;
determining a per-round regret lower bound, wherein a corresponding regret is measured against a benchmark; and
providing the multi-armed bandit problem to an algorithm that has a per-round regret that is close to the determined per-round regret lower bound, wherein the algorithm dynamically adapts to changes and discards irrelevant past information by:
alternating between recently pulled arms and unpulled arms having potential, wherein the alternating comprises updating an estimate of an expected reward of each arm within each epoch and an estimate for an error bound that captures an amount of error contained in the estimate of the expected reward for each arm within each epoch based on an auto-regressive temporal structure with trend components; and
restarting the algorithm.

16. The system of claim 15, wherein the restarting is performed after one epoch of the algorithm is concluded.

17. The system of claim 16, wherein the restarting the algorithm further comprises discarding reward estimates that were maintained for each arm and emptying a set of triggered arms to create revised reward estimates of expected rewards for each arm.

18. The system of claim 16, wherein the restarting the algorithm further comprises examining arms that are not necessarily triggered but have a potential to surpass triggered arms in terms of reward.

19. The system of claim 15, wherein the determined per-round regret lower bound is characterized as a function of a stochastic rate of change σ and a temporal correlation of rewards α.

20. The system of claim 15, wherein an expected reward rᵢ(t) follows an independent AR-1 process with reflective boundaries [−R, R].

21. The system of claim 15, wherein the alternating between recently pulled arms and unpulled arms with potential further comprises selecting a superior arm expected to have a higher reward than expected rewards of other competing arms based on recently collected information.

22. The system of claim 15, wherein the alternating between recently pulled arms and unpulled arms with potential further comprises selecting a triggered arm of a set of triggered arms that has a potential to outperform a superior arm.

23. The system of claim 15, wherein all arms share a heterogeneous temporal correlation of rewards α_{i,j} and have heterogeneous stochastic rates of change σ_{i,j}.

24. The system of claim 15, further comprising estimating temporal correlation of the rewards α_{i,j} using the maximum likelihood estimator.

25. The system of claim 15, wherein, for any fixed stochastic rate of change σ∈(0, 1), a stationary distribution of a given expected reward rᵢ(t) is approximated by a uniform distribution when a corresponding temporal correlation of rewards α approaches a value of one from a given threshold and the stationary distribution of the given expected reward rᵢ(t) is approximated by a normal distribution when the corresponding temporal correlation of rewards α approaches a value of zero from the given threshold.
